(19) United States
(12) Patent Application Publication
(10) Pub. No.: US 2017/0217825 A1
(43) Pub. Date: Aug. 3, 2017

(54) COVER MEMBER

(71) Applicant: ASAHI GLASS COMPANY, LIMITED, Chiyoda-ku (JP)

(72) Inventors: Tomoharu HASEGAWA, Tokyo (JP); Seiki OHARA, Tokyo (JP); Shinichi UNAYAMA, Tokyo (JP); Hiroyuki YAMAMOTO, Tokyo (JP)

(73) Assignee: ASAHI GLASS COMPANY, LIMITED, Chiyoda-ku (JP)

(21) Appl. No.: 15/489,169

(22) Filed: Apr. 17, 2017

Related U.S. Application Data
(63) Continuation of application No. PCT/JP2015/079166, filed on Oct. 15, 2015.

(30) Foreign Application Priority Data
Oct. 17, 2014 (JP) 2014-213224

(51) Int. Cl. C03C 3/087; C03C 21/00; C03C 4/02; C03C 3/091; C03C 10/00; C03C 4/18; C03C 17/32; C03C 3/085

(52) U.S. Cl. CPC C03C 3/087; C03C 17/32; C03C 21/002; C03C 3/085; C03C 3/091; C03C 10/0054; C03C 10/0018; C03C 4/18; C03C 4/02; C03C 2204/00

(57) ABSTRACT

A cover member includes at least a chemically strengthened glass. The chemically strengthened glass has a Young's modulus of 60 GPa or higher. The chemically strengthened glass includes a first surface and a second surface facing the first surface. The chemically strengthened glass has a thickness t of 0.4 mm or less.

### TECHNICAL FIELD

The present invention relates to a cover member.

### BACKGROUND ART

Recently, a method of using a fingerprint for personal authentication has been actively used as an advanced security measure for electronic apparatuses and information apparatuses. Examples of the fingerprint authentication method include an optical type, a heat-sensitive type, a pressure-sensitive type, and a capacitance type. From the viewpoint of sensitivity and power consumption, a capacitance type is considered to be excellent.

When a detection object approaches or contacts a portion of a capacitance sensor, the capacitance sensor detects a change in the local capacitance at the portion. In configuration of a general capacitance sensor (hereinafter, also simply referred to as a sensor), the distance between an electrode arranged in the sensor and a detection object is measured based on the capacitance value. As disclosed in PTL 1, in a case of the fingerprint authentication, an image is obtained by using the properties in which the capacitance is decreased in a concave portion and is increased in a convex portion in accordance with the degree of convex and concave of a fingerprint. That is, by arranging electrodes in the sensor in a matrix manner and measuring the capacitance of each electrode, it is possible to recognize a fingerprint having a convex and concave pattern.

A system with a fingerprint authentication function using these capacitance sensors is small and lightweight and has low power consumption. Therefore, this system is particularly mounted on a portable device such as a smartphone, a mobile phone, or a tablet personal computer. Usually, in order to protect the sensor, a protective cover is provided on/above the sensor.

In the related art, a resin material or the like has been used in the cover member. For example, PTL 2 discloses a film for a fingerprint authentication sensor, which is obtained by using a resin material such as polyethylene terephthalate.

In addition, PTL 3 discloses a member obtained by using sapphire as a cover member for a capacitance sensor which is used for the fingerprint authentication.

### CITATION LIST

### Patent Literature

[PTL 1] JP-A-H09-218006

[PTL 2] JP-A-2003-280759

[PTL 3] WO-A1-2013/173773

### SUMMARY OF INVENTION

### Technical Problem

For the capacitance sensor, particularly, the fingerprint authentication sensor, further improvement in sensitivity has been required. In addition, in a case where the capacitance sensor is mounted on a portable device or the like, there is a danger of dropping or collision due to its external use. Such a cover member for a capacitance sensor has required high mechanical strength for preventing cracks due to impact of dropping or collision.

In order to increase the capacitance, it is conceivable to make the thickness (sheet thickness) of the cover member smaller. However, in a case of a resin material or the like in the related art, when the thickness of the cover member is made smaller, the mechanical strength is deteriorated, which is a problem. Therefore, a material for realizing both a thin sheet thickness and high mechanical strength has been required.

### Solution to Problem

The present inventors have found that the above-described problems are solved by providing a cover member having a thin sheet thickness and high mechanical strength, as a cover member for a capacitance sensor, and thus, the present invention has been completed.

That is, the cover member in an embodiment of the present invention includes at least a chemically strengthened glass, and the chemically strengthened glass has a Young's modulus of 60 GPa or higher, the chemically strengthened glass includes a first surface and a second surface facing the first surface, and the chemically strengthened glass has a thickness t of 0.4 mm or less.

In addition, in the present embodiment, a cover glass including a chemically strengthened glass which has a Young's modulus of 60 GPa or higher and a thickness t of 0.4 mm or less is provided.

In addition, the cover member in another embodiment of the present invention include at least a glass, the glass has a Young's modulus of 60 GPa or higher, the glass includes a first surface and a second surface facing the first surface, and the glass has a thickness t of 0.4 mm or less.

In addition, in the present embodiment, a cover glass including a glass which has a Young's modulus of 60 GPa or higher and a thickness t of 0.4 mm or less is provided.

### Advantageous Effects of Invention

In the present invention, the cover member which is capable of highly contributing to the improvement in sensitivity of the capacitance sensor and has high mechanical strength can be provided.

### BRIEF DESCRIPTION OF DRAWINGS

FIG. 1 illustrates a cross-sectional view of an example of a fingerprint authentication sensor.

### DESCRIPTION OF EMBODIMENTS

Hereinafter, an embodiment of the present invention will be described. However, the present invention is not limited to the following embodiment. In addition, within a range not departing from the scope of the present invention, various modifications and substitutions can be made for the following embodiment.

### First Embodiment

First, a first embodiment of the present invention will be described.

(Cover Member)

A cover member according to the first embodiment of the present invention includes at least a chemically strengthened glass, in which the chemically strengthened glass has a Young's modulus of 60 GPa or higher, the chemically strengthened glass includes a first surface and a second surface facing the first surface, and the chemically strengthened glass has a thickness t of 0.4 mm or less. The cover member of the present embodiment is usefully used, for example, for serving as one member for operating a capacitance sensor, and protecting a sensor portion. In the following description, the cover member of the present embodiment is simply referred to as the “cover member” in some cases.

The cover member of the present embodiment includes at least a chemically strengthened glass. The chemically strengthened glass includes a compressive stress layer that is formed in a surface layer thereof by a chemical strengthening treatment, and thus, the high mechanical strength can be maintained even when the thickness is made smaller so as to increase the capacitance to be detected.

The chemically strengthened glass in the cover member of the present embodiment includes the first surface and the second surface facing the first surface. The first surface of the chemically strengthened glass is a surface opposite to a sensor side when the cover member is provided on/above the capacitance sensor. In addition, the second surface of the chemically strengthened glass is a surface facing the first surface, and is a surface positioned on the sensor side when the cover member is provided on/above the capacitance sensor.

The thickness t of the chemically strengthened glass in the cover member of the present embodiment is 0.4 mm or less, is preferably 0.35 mm or less, is more preferably 0.3 mm or less, is still more preferably 0.25 mm or less, is particularly preferably 0.2 mm or less, and is most preferably 0.1 mm or less. As the thickness of the chemically strengthened glass in the cover member becomes smaller, the detected capacitance becomes increased, and thus, the sensitivity is improved. For example, in the case of fingerprint authentication in which fine convex and concave portions of a fingerprint of a fingertip are detected, a difference in the capacitances in accordance with the fine convex and concave portions of the fingerprint of the fingertip is increased. Therefore, the detection can be performed with high sensitivity. On the other hand, the lower limit of the thickness of the chemically strengthened glass in the cover member of the present embodiment is not particularly limited. However, when the thickness of the chemically strengthened glass is excessively small, the strength is deteriorated, and thus, it tends to be difficult to appropriately function as a cover member. Accordingly, the thickness of the chemically strengthened glass is, for example, 0.01 mm or more and more preferably 0.05 mm or more.

When the cover member of the present embodiment is provided on/above the capacitance sensor, in the chemically strengthened glass in the cover member, only an area facing the capacitance sensor may be thinned. Accordingly, in the chemically strengthened glass, the thickness of an area which does not face the capacitance sensor may be larger than 0.4 mm. With this, the rigidity of the cover member is enhanced.

Further, the cover member of the present embodiment and the chemically strengthened glass in the cover member may be formed in a three-dimensional shape, and for example, the first surface of the chemically strengthened glass can be a convex or concave surface.

The Young's modulus of the chemically strengthened glass in the cover member of the present embodiment is 60 GPa or higher, is preferably 65 GPa or higher, and is more preferably 70 GPa or higher. When the Young's modulus of the chemically strengthened glass is 60 GPa or higher, damage to the cover member caused by collision with a foreign object from the outside can be sufficiently prevented. In addition, when the capacitance sensor is mounted on the portable device or the like, damage to the cover member caused by dropping or collision of the portable device or the like can be sufficiently prevented. Further, damage to the sensor portion protected by the cover member can be sufficiently prevented. In addition, the upper limit of the Young's modulus of the chemically strengthened glass in the cover member of the present embodiment is not particularly limited. From the viewpoint of productivity, the Young's modulus of the chemically strengthened glass is, for example, 200 GPa or lower, and is preferably 150 GPa or lower. The Young's modulus of the chemically strengthened glass can be measured by measuring a test piece of 20 mm in length×20 mm in width×10 mm in thickness by using ultrasonic waves, based on Japanese Industrial Standards JIS R 1602 (1995).

The Vickers hardness Hv of the chemically strengthened glass in the cover member of the present embodiment is preferably 400 or higher, and is more preferably 500 or higher. When the Vickers hardness of the chemically strengthened glass is 400 or higher, scratches on the cover member caused by collision with a foreign collision object from the outside can be sufficiently prevented. In addition, in a case where the capacitance sensor is mounted on the portable device or the like, scratches on the cover member caused by dropping or collision of the portable device or the like can be sufficiently prevented. Further, damage to the sensor portion protected by the cover member can be sufficiently prevented. In addition, the upper limit of the Vickers hardness of the chemically strengthened glass in the cover member of the present embodiment is not particularly limited. However, when the Vickers hardness is excessively high, there may be a problem in polishing or processing. Accordingly, the Vickers hardness of the chemically strengthened glass is, for example, 1200 or lower and preferably 1000 or lower.

The Vickers hardness of the chemically strengthened glass in the cover member of the present embodiment can be measured in a Vickers hardness test described in, for example, Japanese Industrial Standards JIS Z 2244 (2009).

The relative permittivity of the chemically strengthened glass in the cover member of the present embodiment at a frequency of 1 MHz is preferably 5 or higher, is more preferably 7 or higher, is still more preferably 7.2 or higher, and is particularly preferably 7.5 or higher. When the relative permittivity of the chemically strengthened glass is increased, the detected capacitance can be increased, thereby realizing the capacitance sensor having superior sensitivity. In particular, when the relative permittivity of the chemically strengthened glass in the cover member at a frequency of 1 MHz is 7 or higher, even in the case of fingerprint authentication in which fine convex and concave portions of the fingerprint of the fingertip are detected, a difference in the capacitance in accordance with the fine convex and concave portions of the fingerprint of the fingertip increases. Therefore, the detection can be performed with high sensitivity. In addition, the upper limit of the relative permittivity of the chemically strengthened glass in the cover member of the present embodiment is not particularly limited. However, when the relative permittivity is excessively high, dielectric loss may increase, power consumption may increase, and a reaction may become slow. The relative permittivity of the chemically strengthened glass at a frequency of 1 MHz is, for example, preferably 20 or lower and more preferably 15 or lower.

The relative permittivity of the chemically strengthened glass in the cover member of the present embodiment can be determined by measuring the capacitance of a capacitor in which electrodes are formed on both surfaces of the chemically strengthened glass by using, for example, an AC impedance method.

The arithmetic average roughness (Ra) of the surface of the chemically strengthened glass in the cover member of the present embodiment is not particularly limited; however, the arithmetic average roughness Ra of the first surface is preferably 300 nm or lower, and is more preferably 30 nm or lower. When the arithmetic average roughness Ra of the first surface is 300 nm or lower, it is sufficiently small as compared with the degree of convex and concave of a fingerprint of a finger, and thus, the above range is preferable from the viewpoint of increasing the sensitivity. In addition, the lower limit of the arithmetic average roughness Ra of the first surface of the chemically strengthened glass is also not particularly limited; however, it is preferably 0.3 nm or higher, and is more preferably 1.0 nm or higher. The arithmetic average roughness Ra of the first surface of the chemically strengthened glass is preferably 0.3 nm or higher from the viewpoint of increasing the strength. The arithmetic average roughness Ra of the first surface of the chemically strengthened glass can be adjusted by the selection of, for example, an abrasive grain or a polishing method. In addition, the arithmetic average roughness Ra of the first surface of the chemically strengthened glass can be measured based on Japanese Industrial Standards JIS B0601 (1994).

On the other hand, the arithmetic average roughness Ra of the second surface of the chemically strengthened glass is also not particularly limited and may be the same as or different from that of the first surface.

Hereinafter, regarding the cover member of the present embodiment, a method of manufacturing the cover member, and preferred embodiment of the cover member will be described in order.

(Method of Manufacturing Cover Member)

In the method of manufacturing of the cover member of the present embodiment, the respective steps are not particularly limited and may be appropriately selected, and typically conventional steps can be applied. For example, first, raw materials of the respective components are prepared so as to have a composition described below, followed by heating and melting in a glass furnace. A glass is homogenized by, for example, bubbling, stirring, or addition of a fining agent, and the homogenized glass is formed into a glass plate having a predetermined thickness using a conventional forming method, and then, the glass plate is cooled slowly.

Examples of the glass forming method include a float method, a press method, a fusion method, a down-draw method, and a roll-out method. In particular, a float method suitable for mass production is preferable. In addition, continuous forming methods other than the float method, that is, the fusion method and the down-draw method are also preferable. In addition, in a case where a colored glass is formed, the roll-out method may be optimal. Further, in a case where the glass is formed into a shape other than a flat plate shape, for example, a concave shape or a convex shape, the glass formed into a flat plate shape or a block shape is reheated, and pressed in the molten state, and the molten glass flows out onto the press die and press-formed, and thereby the glass is formed in a desired shape.

The formed glass is ground and polished as necessary, is subjected to the chemical strengthening treatment, and then is washed and dried. Thereafter, the cover member of the present embodiment can be obtained by performing the processing such as cutting and polishing.

The chemical strengthening treatment refers to a treatment of substituting (ion exchanging) alkali ions (for example, sodium ions) having a small ionic radius in the surface layer of the glass with alkali ions (for example, potassium ions) having a large ionic radius. The method of the chemical strengthening treatment is not particularly limited as long as alkali ions in the surface layer of the glass can be exchanged with alkali ions having a larger ionic radius. For example, the chemical strengthening treatment can be performed by treating glass containing sodium ions with molten salt containing potassium ions. Due to the above-described ion exchange treatment, the composition of a deep part of a substrate is substantially the same as the composition thereof before the ion exchange treatment although the composition of a compressive stress layer in a glass surface layer is slightly different from the composition thereof before the ion exchange treatment.

In a case where the glass containing the composition described below is used as the glass to be chemically strengthened, it is preferable that molten salt containing at least potassium ions is used as the molten salt for the chemical strengthening treatment. Preferable examples of the molten salt include potassium nitrate. In this regard, the sodium nitrate may be contained; however, the surface compressive stress may be decreased due to the sodium ion. For this reason, in order to obtain the sufficient surface compressive stress, the content of the sodium nitrate in the molten salt is preferably 10% by mass or less, is more preferably 8% by mass or less, and is still more preferably 5% by mass or less.

In addition, other components may be contained in mixed molten salt. Examples of the other components include: an alkali sulfate such as sodium sulfate or potassium sulfate; an alkali chloride such as sodium chloride or potassium chloride; a carbonate such as sodium carbonate or potassium carbonate; and bicarbonate such as sodium bicarbonate or potassium bicarbonate.

In the present embodiment, conditions for the chemical strengthening treatment are not particularly limited, and can be appropriately selected from conventional methods.

The heating temperature of the molten salt is preferably 350° C. or higher, more preferably 380° C. or higher, and still more preferably 400° C. or higher. In addition, the heating temperature of the molten salt is preferably 500° C. or lower, more preferably 480° C. or lower, and still more preferably 450° C. or lower. By adjusting the heating temperature of the molten salt to be 350° C. or higher, a problem that chemical strengthening is less likely performed, caused by a decrease in ion exchange rate, is prevented. In addition, by adjusting the heating temperature of the molten salt to be 500° C. or lower, the decomposition and deterioration of the molten salt can be suppressed.

In order to impart sufficient compressive stress, the contact time between the glass and the molten salt is preferably 1 hour or longer and more preferably 2 hours or longer. In addition, when the ion exchange treatment is performed for a long period of time, the productivity decreases, and the compressive stress decreases due to relaxation. Therefore, the contact time is preferably 24 hours or shorter and more preferably 20 hours or shorter. Specifically, for example, the glass is typically dipped in molten potassium nitrate at 400° C. to 450° C. for 2 to 24 hours.

(Chemically Strengthened Glass)

The chemically strengthened glass (hereinafter, also simply referred to as the glass of the present embodiment) used in the cover member of the present embodiment include a compressive stress layer in the surface layer thereof formed by the chemical strengthening treatment.

The surface compressive stress (CS) of the compressive stress layer is preferably 300 MPa or higher and more preferably 400 MPa or higher. CS can be measured using a surface stress meter (for example, FSM-6000, manufactured by Orihara Manufacturing Co., Ltd.).

In addition, in the glass of the present embodiment, the CS of the glass which has been chemically strengthened by potassium nitrate at 450° C. for six hours is preferably 75% or higher, more preferably 80% or higher, and particularly preferably 85% or higher, of the CS of the glass which has been chemically strengthened by potassium nitrate at 400° C. for six hours. When the surface compressive stress of the glass which has been chemically strengthened by potassium nitrate at 450° C. for six hours is controlled to be 75% or higher of the surface compressive stress of the glass which has been chemically strengthened by potassium nitrate at 400° C. for six hours, even in a case where the chemical strengthening is performed at high temperature of 400° C. or higher, it is possible to obtain a cover member which has small change due to temperature and time in the surface compressive stress, stable chemical strengthening properties, and excellent productivity.

In order to obtain the effective effect of improving surface hardness by the chemical strengthening, the deep surface compressive stress layer is preferable, and the depth of the surface compressive stress layer (Depth of Layer, DOL) generated by the chemical strengthening is preferably 6 μm or more. In addition, when the scratches exceeding the DOL are generated, it leads to destruction of the glass, and thus, the DOL is preferably 10 μn or more, is more preferably 15 μn or more, is further more preferably 20 μm more, and is most preferably 30 μm more.

Particularly, in a case where the thickness t of the glass is smaller than 0.4 mm, it is preferable to satisfy the relation of DOL/t≧0.05 in order to sufficiently withstand impacts from the outside. The thickness t more preferably satisfies the relation of DOL/t≧0.09, still more preferably satisfies the relation of DOL/t≧0.11, and most preferably satisfies the relation of DOL/t≧0.13.

On the other hand, when the DOL is excessively large, the internal tensile stress becomes larger, and thus, the impact upon destruction is increased. For this reason, the DOL is preferably 70 μm or less, is more preferably 60 μm or less, is still more preferably 50 μm or less, and is most preferably 40 μm or less.

In a case where sodium ions in a glass surface layer are exchanged with potassium ions in molten salt by chemical strengthening, the DOL can be measured using an arbitrary method. For example, using an electron probe micro-analyzer (EPMA), the alkali ion concentration (in this example, potassium ion concentration) in the depth direction of the glass is analyzed, and the ion diffusion depth obtained by the measurement can be set as DOL. In addition, DOL can be measured using a surface stress meter (for example, FSM-6000, manufactured by Orihara Manufacturing Co., Ltd.). In addition, when lithium ions in a glass surface layer are exchanged with sodium ions in molten salt, the sodium ion concentration in the depth direction of the glass is analyzed using an EPMA, and the ion diffusion depth obtained by the measurement is set as DOL.

The internal tensile stress (Central Tension; CT) of the glass of the present embodiment is preferably 200 MPa or lower, more preferably 150 MPa or lower, still more preferably 100 MPa or lower, and most preferably 80 MPa or lower. In general, CT can be approximately obtained from the relational expression “CT=(CS×DOL)/(t−2×DOL)” wherein t represents the thickness of the glass.

In the present embodiment, the strain point of the glass before chemical strengthening is preferably 530° C. or higher. By adjusting the strain point of the glass before chemical strengthening to be 530° C. or higher, the relaxation of the surface compressive stress is not likely to occur.

It is preferable that a printing layer is provided on the second surface of the chemically strengthened glass used in the cover member of the present embodiment. By providing the printing layer, a capacitance sensor can be effectively prevented from being recognized by sight through the cover member, a desired color can be imparted thereto, and a good appearance can be obtained. From the viewpoint of maintaining high capacitance of the cover member, the thickness of the printing layer is preferably 20 μm or less, more preferably 15 μm or less, and particularly preferably 10 μm or less.

In the case where the printing layer is provided, in the cover member of the present embodiment, the minimum value of absorbance at the wavelength in a range of 380 nm to 780 nm is preferably 0.01 or higher, is more preferably 0.05 or higher, is still more preferably 0.10 or higher, even still more preferably 0.20 or higher, and is particularly preferably 0.30 or higher. When the minimum value of absorbance is controlled to be 0.01 or higher, it is possible to obtain desired light shielding properties, and thus it is possible to effectively suppress the transmission of light to the cover member.

In the case where the printing layer is provided, in the cover member of the present embodiment, the minimum value of absorption coefficient at the wavelength in a range of 380 nm to 780 nm is preferably 0.3 mm⁻¹ or higher, is more preferably 0.7 mm⁻¹ or higher, is still more preferably 1 mm⁻¹ or higher, is even still more preferably 2 mm⁻¹ or higher, is even still more preferably 3 mm⁻¹ or higher, and is particularly preferably 4 mm⁻¹ or higher. When the minimum value of the absorption coefficient is controlled to be 0.3 mm⁻¹ or higher, it is possible to obtain the desired light shielding properties, and thus, it is possible to effectively suppress the transmission of light to the cover member.

A method of calculating the absorbance of the glass of the present embodiment is performed in the following manner. Both surfaces of a glass plate are mirror polished and the thickness t is measured. The spectrum permeability T of the glass plate is measured (for example, a UV-visible near-infrared spectrophotometer V-570 manufactured by JASCO Corporation is used). Then, absorbance A is calculated by using the relation expression of A=−log₁₀ T.

A method of calculating the absorption coefficient of the glass of the present embodiment is performed in the following manner. Both surfaces of a glass plate are mirror polished and the thickness t is measured. The spectrum permeability T of the glass plate is measured (for example, a UV-visible near-infrared spectrophotometer V-570 manufactured by JASCO Corporation is used). Then, the absorption coefficient β is calculated by using the relation expression of T=10^{-βt}.

The printing layer can be formed of an ink composition containing a predetermined color material. In addition to the color material, the ink composition may contain a binder, a dispersant, a solvent and the like according to need. The color material may be a color material (colorant) such as a pigment or a dye. Among these, one kind or a combination of two or more kinds can be used. The color material can be appropriately selected according to a desired color. For example, in a case where the light shielding properties are required, for example, a black color material is preferably used. In addition, the binder is not particularly limited, and examples thereof include conventional resins (for example, a thermoplastic resin, a thermosetting resin, or a photo curable resin) such as a polyurethane resin, a phenol resin, an epoxy resin, an urea melamine resin, a silicone resin, a phenoxy resin, a methacrylic resin, an acrylic resin, a polyacrylate resin, a polyester resin, a polyolefin resin, a polystyrene resin, polyvinyl chloride, a vinyl chloride-vinyl acetate copolymer, polyvinyl acetate, polyvinylidene chloride, polycarbonate, cellulose, or polyacetal. Among these, one kind or a combination of two or more kinds can be used as the binder.

A printing method for forming the printing layer is not particularly limited, and an appropriate printing method such as a gravure printing method, a flexographic printing method, an offset printing method, a relief printing method, or a screen printing method can be used.

The absorbance and the absorption coefficient of the cover member including the glass of the present embodiment and the printing layer can be calculated by using the same method as the method of calculating the absorbance and the absorption coefficient of the above-described glass.

In addition, the cover member of the present embodiment may include the printing layer on the first surface of the glass as necessary. Further, in accordance with the desired function and properties, other layers such as an antiglare layer, an antireflection layer, and a fingerprint resistant layer (AFP layer) by etching and coating with a coating liquid, a protective film, and an adhesive layer for lamination may be properly provided in addition to the printing layer.

Hereinafter, several preferred embodiments of the glass (glass for chemical strengthening) to be subjected to the chemical strengthening will be described in detail.

(Substantially Colorless Transparent Glass)

First, substantially colorless transparent glass which is one preferred embodiment as the glass to be subjected to the chemical strengthening will be described. Hereinafter, when % is used as the composition of the glass, it is assumed to be represented by mol % in terms of oxides.

SiO₂ is a component of forming network of glass and improving the weatherability, and the content thereof is preferably 50% or more, is more preferably 55% or more, is still more preferably 60% or more, is even still more preferably 61% or more, is even still more preferably 63% or more, and is particularly preferably 68% or more. In order to increase the meltability without increasing the viscosity of the glass, the content of SiO₂ is preferably 80% or less, is more preferably 75% or less, is still more preferably 73% or less, and is particularly preferably 70% or less.

Al₂O₃ is a component of improving the weatherability of the glass, and the content thereof is preferably 0.25% or more, is more preferably 1% or more, is still more preferably 2% or more, and is particularly preferably 3% or more. In order to increase the meltability without increasing the viscosity of the glass, the content of Al₂O₃ is preferably 25% or less, is more preferably 16% or less, is still more preferably 10% or less, is still more preferably 8% or less, is still more preferably 7% or less, and is particularly preferably 6% or less.

B₂O₃ is a component of forming network of glass and improving the weatherability, and the content thereof is preferably 0.5% or more, is more preferably 1% or more, is still more preferably 2% or more, and is particularly preferably 3% or more. In order to prevent striae due to volatilization, the content of B₂O₃ is preferably 15% or less, is more preferably 12% or less, is still more preferably 10% or less, and is particularly preferably 9% or less.

P₂O₅ is a component of forming network of glass, and the content thereof is preferably 0.5% or more, is more preferably 2% or more, and is still more preferably 3% or more. In order to improve the weatherability, the content of P₂O₅ is preferably 10% or less, is more preferably 8% or less, is still more preferably 7% or less, and is particularly preferably 6% or less.

Na₂O is a component of improving the meltability of the glass, and a component of forming a surface compressive stress layer by the ion exchanging. The content thereof is preferably 1% or more, is more preferably 3% or more, is still more preferably 4% or more, is even still more preferably 5% or more, is even still more preferably 6% or more, is even still more preferably 7% or more, and is particularly preferably 8% or more. In order to improve the weatherability, the content of Na₂O is preferably 20% or less, is more preferably 17% or less, is still more preferably 15% or less, is even still more preferably 14% or less, is even still more preferably 13% or less, and is particularly preferably 11% or less.

K₂O is a component of improving the meltability, and a component of increasing the ion exchange rate in the chemical strengthening. The content thereof is preferably 1% or more, is more preferably 2% or more, and is still more preferably 3% or more. In order to improve the weatherability, the content of K₂O is preferably 15% or less, is more preferably 10% or less, is still more preferably 9% or less, is even still more preferably 7% or less, is even still more preferably 6% or less, and is particularly preferably 5% or less.

Li₂O is a component of increasing the relative permittivity and improving the Young's modulus and the meltability. The content thereof is preferably 0.5% or more, is more preferably 1% or more, and is still more preferably 3% or more. In order to improve the weatherability, the content of Li₂O is preferably 15% or less, is more preferably 10% or less, and is still more preferably 5% or less.

MgO is a component of improving the meltability, and the content thereof is preferably 1% or more, is more preferably 5% or more, is still more preferably 7% or more, and is particularly preferably 10% or more. In order to improve the weatherability, the content of MgO is preferably 30% or less, is more preferably 25% or less, is still more preferably 20% or less, is even still more preferably 15% or less, is even still more preferably 13% or less, and is particularly preferably 12% or less.

CaO is a component of improving the meltability, and the content thereof is preferably 0.1% or more, is more preferably 1% or more, and is still more preferably 2% or more. In order to improve the weatherability, the content of CaO is preferably 15% or less, is more preferably 13% or less, is still more preferably 10% or less, is even still more preferably 7% or less, is even still more preferably 6% or less, and is particularly preferably 5% or less.

SrO is a component of improving the meltability, and the content thereof is preferably 0.1% or more, is more preferably 1% or more, is still more preferably 2% or more, is even still more preferably 3% or more, and is particularly preferably 6% or more. In order to improve the weatherability, the content of SrO is preferably 15% or less, is more preferably 12% or less, is still more preferably 10% or less, is even still more preferably 9% or less, and is particularly preferably 8% or less.

BaO is a component of increasing the relative permittivity and improving the meltability. In a case where the relative permittivity is intended to be increased or the meltability is intended to be improved, the content thereof is preferably 0.1% or more, is more preferably 1% or more, is still more preferably 3% or more, is even still more preferably 5% or more, and is particularly preferably 6% or more. In order to improve the weatherability, the content of BaO is preferably 15% or less, is more preferably 12% or less, is still more preferably 10% or less, is even still more preferably 9% or less, and is particularly preferably 8% or less.

ZnO is a component of improving the meltability, and the content thereof is preferably 1% or more, is more preferably 3% or more, and is particularly preferably 6% or more. In order to improve the weatherability, the content of ZnO is preferably 15% or less, is more preferably 12% or less, is still more preferably 9% or less.

RO (R is Mg, Ca, Sr, Ba, and Zn) are component(s) of improving the meltability, although it is not essential, it is possible to contain any one or more kinds thereof as necessary. In that case, a total content ΣRO (R is Mg, Ca, Sr, Ba, and Zn) of RO's is preferably 1% or more, is more preferably 5% or more, and is particularly preferably 10% or more. In order to improve the weatherability, ΣRO (R is Mg, Ca, Sr, Ba, and Zn) is preferably 25% or less, is more preferably 20% or less, is still more preferably 18% or less, and is particularly preferably 16% or less.

ZrO₂ is a component of increasing the relative permittivity and increasing the ion exchange rate. The content thereof is preferably 0.5% or more, is more preferably 1% or more, and is still more preferably 2% or more. In order to prevent ZrO₂ from remaining in the glass as an unmelted matter, the content of ZrO₂ is preferably 5% or less, is more preferably 4% or less, and is still more preferably 3% or less.

TiO₂ is a component of increasing the relative permittivity and improving the weatherability. The content thereof is preferably 0.5% or more, is more preferably 1% or more, and is still more preferably 2% or more. In order to improve the stability of the glass, the content of TiO₂ is preferably 12% or less, is more preferably 10% or less, is still more preferably 8% or less, is even still more preferably 5% or less, and is particularly preferably 3% or less.

SO₃ is a component which acts as a clarifying agent, and the content thereof is preferably 0.005% or more, is more preferably 0.01% or more, is still more preferably 0.02% or more, and is particularly preferably 0.03% or more. In order to reduce the number of bubbles in the glass, the content of SO₃ is preferably 0.5% or less, is more preferably 0.3% or less, is still more preferably 0.2% or less, and is particularly preferably 0.1% or less.

In order to reduce the number of bubbles in the glass, the glass of the present embodiment may contain Sb₂O₃, SnO, Cl, F, and other components. In a case of containing such component(s), the total content of the component(s) is preferably 1% or less, and is more preferably 0.5% or less.

In addition, the glass of the present embodiment is a typically substantially colorless transparent glass; however, it may contain crystals derived from the glass component therein. The color of the aforementioned crystal depends on the kinds of the crystal and, for example, black and white can be adopted.

As the substantially colorless transparent glass used in the cover member of the present embodiment, for example, any one of the following glasses (i) to (v) may be used. The following glass compositions are represented by mol % in terms of oxides.

(i) A glass containing 50% to 80% of SiO₂, 2% to 25% of Al₂O₃, 0% to 10% of Li₂O, 0% to 18% of Na₂O, 0% to 10% of K₂O, 0% to 15% of MgO, 0% to 5% of CaO, and 0% to 5% of ZrO₂.

(ii) A glass containing 50% to 74% of SiO₂, 1% to 10% of Al₂O₃, 6% to 14% of Na₂O, 3% to 11% of K₂O, 2% to 15% of MgO, 0% to 6% of CaO, and 0% to 5% of ZrO₂, in which a total content of SiO₂ and Al₂O₃ is 75% or lower, a total content of Na₂O and K₂O is 12% to 25%, and a total content of MgO and CaO is 7% to 15%.

(iii) A glass containing 68% to 80% of SiO₂, 4% to 10% of Al₂O₃, 5% to 15% of Na₂O, 0% to 1% of K₂O, 4% to 15% of MgO, and 0% to 1% of ZrO₂, in which a total content of SiO₂ and Al₂O₃ is 80% or lower.

(iv) A glass containing 67% to 75% of SiO₂, 0% to 4% of Al₂O₃, 7% to 15% of Na₂O, 1% to 9% of K₂O, 6% to 14% of MgO, 0% to 1% of CaO, and 0% to 1.5% of ZrO₂, in which a total content of SiO₂ and Al₂O₃ is 71% to 75%, and a total content of Na₂O and K₂O is 12% to 20%.

(v) A glass containing 60% to 75% of SiO₂, 0.5% to 8% of Al₂O₃, 10% to 18% of Na₂O, 0% to 5% of K₂O, 6% to 15% of MgO, and 0% to 8% of CaO.

(Colored Glass)

Subsequently, substantially colored glass in another preferred embodiment of the glass which is subjected to the chemical strengthening will be described.

The colored glass of the present embodiment further contains a coloring component in addition to the same composition as that of the substantially colorless transparent glass in another embodiment as described above, and the appearance thereof exhibits a predetermined color.

The colored glass has color imparted to the glass, and thus, in a case of exhibiting dark color, it is possible to hide the inside of the capacitance sensor such as a fingerprint authentication sensor without providing the printing layer (shielding layer) on the back surface (the second surface) side of the glass. In addition, it is possible to impart an excellent aesthetic appearance to the cover member by setting a desired color (without limiting to dark color or light color).

Further, the colored glass mainly contains transition metal components as a coloring component. These transition metal components are the component of adjusting the relative permittivity. Therefore, by adjusting components that are contained and the contents thereof, it is possible to obtain a glass having desired relative permittivity which is suitable as a cover member.

Hereinafter, when % is used as the composition of the glass, it is assumed to be represented by mol % in terms of oxides.

The coloring components (at least one metal oxide selected from the group consisting of oxides of Co, Mn, Fe, Ni, Cu, Cr, V, Bi, Se, Pr, Ce, Eu, Er, Nd, W, Rb, Sn, and Ag) are components of adjusting the relative permittivity desirably, and obtaining desired light shielding properties and color tone. The content of the coloring components is preferably in a range of 0.001% to 7%, is more preferably in a range of 0.1% to 6%, and is still more preferably in a range of 0.5% to 5%. As the coloring components (at least one metal oxide selected from the group consisting of oxides of Co, Mn, Fe, Ni, Cu, Cr, V, Bi, Se, Pr, Ce, Eu, Er, Nd, W, Rb, Sn, and Ag), specifically, Co₃O₄, MnO, MnO₂, Fe₂O₃, Fe₃O₄, NiO, CuO, Cu₂O, Cr₂O₃, V₂O₅, Bi₂O₃, SeO, Na₂SeO₃, Pr₆O₁₀, CeO₂, Eu₂O₃, EuO, Er₂O₃, Nd₂O₃, WO₃, Rb₂O, SnO, SnO₂, AgO, and AgNO₃ are preferably used. The coloring components may contain any one of the aforementioned components as long as the total content thereof is in a range of 0.1% to 7%. However, if the content of each component is less than 0.001%, there is a possibility that the effect as a coloring component cannot be sufficiently obtained, and thus, it is preferably 0.001% or more, is more preferably 0.1% or more, and is still more preferably 0.2% or more. In addition, if the content of each component is more than 7%, there is a possibility that the glass becomes unstable and devitrification occurs, and thus, it is preferably 7% or less, is more preferably 6% or less, and is still more preferably 5% or less. The coloring components preferably contain 0.001% to 6% of Fe₂O₃, 0% to 6% of Co₃O₄, 0% to 6% of NiO, 0% to 6% the MnO, 0% to 2.5% of Cr₂O₃, 0% to 6 of V₂O₅, and 0% to 2.5% the CuO. That is, the coloring components may be obtained by combining Fe₂O₃ as an essential component with the components properly selected from Co₃O₄, NiO, MnO, Cr₂O₃, V₂O₅, and CuO. When the contents of the components other than Fe₂O₃, that is, the content of each of Co₃O₄, NiO, MnO, and V₂O₅ is more than 6%, or the content of each of Cr₂O₃ and CuO is more than 2.5%, there is a possibility that the glass becomes unstable.

Fe₂O₃ is a component of coloring the glass to be dark. If the total iron content represented by Fe₂O₃ is less than 0.001%, there is a possibility that a desired black glass cannot be obtained, and thus, it is preferably 0.001% or more, is more preferably 1.5% or more, is still more preferably 2% or more, and is particularly preferably 3% or more. If the content of Fe₂O₃ is more than 7%, the glass becomes unstable and devitrification occurs, and thus, it is preferably 7% or less, is more preferably 5% or less, and is still more preferably 4% or less. The ratio of the content of divalent iron (iron redox) in terms of Fe₂O₃ is preferably in a range of 10% to 50%, is particularly preferably in a range of 15% to 40%, and is most preferably in a range of 20% to 30%, with respect to the entire iron. When the iron redox is less than 10%, in a case of containing SO₃, there is a possibility that the decomposition does not proceed, and thus, the expected clarification effect cannot be obtained. Further, when the iron redox is more than 50%, there is a possibility that the decomposition of SO₃ excessively proceeds before clarification, and thus, the expected clarification effect cannot be obtained, or it may be a source of bubbles, and then, the number of bubbles is increased.

Co₃O₄ is a component of exhibiting a defoaming effect in coexistence with iron. That is, in a high temperature state, O₂ bubbles emitted when trivalent iron becomes divalent iron are absorbed when cobalt is oxidized, and as a result, O₂ bubbles are removed and it is possible to obtain a defoaming effect. Further, Co₃O₄ is a component of further improving the clarifying action when it coexists with SO₃. That is, in a case where mirabilite (Na₂SO₄) is used as a clarifying agent, the defoaming is improved by advancing the reaction of SO₃→SO₂+½O₂, and thus, the oxygen partial pressure is preferably low in the glass. When the cobalt is co-added in the glass containing iron, the emission of oxygen due to the reduction of iron is suppressed by the oxidation of cobalt, and thus, it is possible to manufacture the glass in which the decomposition of SO₃ has been prompted and the bubble defects have been decreased. In addition, the glass having a relatively large amount of alkali metal for the chemical strengthening has high basicity of the glass, and thus, it is hard to decompose SO₃, and thereby the clarifying effect is deteriorated. In the glass to be chemically strengthened in which SO₃ is not easily decomposed and which contains iron, cobalt is particularly effective for prompting the decomposition of SO₃. In order to realize such a clarifying action, the content of Co₃O₄ is preferably 0.1% or more, is more preferably 0.2% or more, and is typically 0.3% or more. When the content of Co₃O₄ is more than 1%, the glass becomes unstable and devitrification occurs, and thus, it is preferably 1% or less, is more preferably 0.8% or less, and is still more preferably 0.6% or less.

When the molar ratio Co₃O₄/Fe₂O₃ of Co₃O₄ to Fe₂O₃ is lower than 0.01, there is a possibility that the above-described effect cannot be obtained, and thus, it is preferably 0.01 or higher, is more preferably 0.05 or higher, and is typically 0.1 or higher. When the ratio Co₃O₄/Fe₂O₃ is higher than 0.5, it may be a source of the bubbles, and thus, the glass may become slowly melted down such that the number of bubbles is increased. Therefore, it is preferably 0.5 or lower, is more preferably 0.3 or lower, and is still more preferably 0.2 or lower.

NiO is a coloring component of coloring the glass to be a desired black. In a case of containing NiO, when the content thereof is less than 0.05%, there is possibility that the effect as the coloring component of NiO cannot be sufficiently obtained, and thus, it is preferably 0.05% or more, is more preferably 0.1% or more, and is still more preferably 0.2% or more. When the content of NiO is more than 6%, the lightness of the color tone of the glass becomes excessively high and a desired black color tone cannot be obtained, and also there is a possibility that the glass becomes unstable and devitrification occurs. Therefore, the content of NiO is preferably 6% or less, is more preferably 5% or less, and is still more preferably 4% or less.

On the other hand, when the content of NiO is less than 0.05%, it is possible to obtain a glass in which foreign matters such as NiS are hardly generated and occurrence of breakage after chemical strengthening is suppressed.

In the case where the printing layer is provided as the cover member on the second surface of the glass of the present embodiment, in the glass of the present embodiment, the minimum value of absorption coefficient at the wavelength in a range of 380 nm to 780 nm is preferably 0.3 mm⁻¹ or higher, is more preferably 1.0 mm⁻¹ or higher, and is still more preferably 1.3 mm⁻¹ or higher. When the minimum value of the absorption coefficient of the glass at the wavelength in a visible region is controlled to be 0.3 mm⁻¹ or higher, white light is absorbed by the glass and the printing layer, and the sufficient light shielding properties can be obtained as the cover member, and further desired relative permittivity can be obtained. In addition, in a case of providing a printing layer having a thickness of 10 μm or larger as the cover member on the second surface of the glass of the present embodiment, when the minimum value of the absorption coefficient of the glass at the wavelength in a range of 380 nm to 780 nm is preferably 0.1 mm⁻¹ or higher, it is possible to obtain desired light shielding properties and a desired relative permittivity.

When the glass is formed into a concave shape or a convex shape, there is a possibility that light transmits the thinnest area. In a case where the glass is thin, the minimum value of the absorption coefficient of the glass at the wavelength in a range of 380 nm to 780 nm is preferably 1.1 mm⁻¹ or higher, is more preferably 1.2 mm⁻¹ or higher, and is still more preferably 1.3 mm⁻¹ or higher.

In addition, the minimum value of the absorbance of the glass of the present embodiment at the wavelength in a range of 380 nm to 780 nm is preferably 0.01 or higher, and is more preferably 0.05 or higher. When the minimum value of the absorbance of the glass at the wavelength of the visible region is 0.01 or higher, white light is absorbed by the glass and the printing layer, and thus, the sufficient light shielding properties can be obtained as the cover member, and further desired relative permittivity can be obtained.

In a case where the glass of the present embodiment is used without providing the printing layer as the cover member on the second surface thereof, the minimum value of the absorbance at the wavelength in a range of 380 nm to 780 nm is preferably 0.10 or higher such that the capacitance sensor is not visible from the outside of the apparatus via the glass. When the minimum value of the absorbance of the glass at the wavelength of the visible region is controlled to be 0.10 or higher, the white light is absorbed only by glass without separately providing light shielding means, and the sufficient light shielding properties can be obtained as the glass, and further desired relative permittivity can be obtained. The minimum value of the absorbance of the glass at the wavelength in a range of 380 nm to 780 nm is more preferably 0.11 or higher, is still more preferably 0.12 or higher, and is particularly preferably 0.14 or higher.

Further, in the cover member including the glass of the present embodiment and the printing layer, the minimum value of the absorption coefficient at the wavelength in a range of 380 nm to 780 nm is preferably 0.7 mm⁻¹ or higher, is more preferably 0.9 mm⁻¹ or higher, is still more preferably 2 mm⁻¹ or higher, is even still more preferably 3 mm⁻¹ or higher, and is particularly preferably 4 mm⁻¹ or higher. When the minimum value of the absorption coefficient is controlled to be 0.7 mm⁻¹ or higher, it is possible to more suitably use as the cover member.

In addition, in the cover member including the glass of the present embodiment and the printing layer, the minimum value of the absorbance at the wavelength in a range of 380 nm to 780 nm is preferably 0.2 or higher, is more preferably 0.5 or higher, is still more preferably 1.0 or higher, is even still more preferably 2.0 or higher, and is particularly preferably 4.0 or higher. When the minimum value of the absorbance is controlled to be 0.2 or higher, it is possible to more suitably use as the cover member.

A method of calculating the absorbance of the glass of the present embodiment is performed in the following manner. Both surfaces of a glass plate are mirror polished and the thickness t is measured. The spectrum permeability T of the glass plate is measured (for example, a UV-visible near-infrared spectrophotometer V-570 manufactured by JASCO Corporation is used). Then, absorbance A is calculated by using the relation of A=−log₁₀ T.

A method of calculating the absorption coefficient of the glass of the present embodiment is performed in the following manner. Both surfaces of a glass plate are mirror polished and the thickness t is measured. The spectrum permeability T of the glass plate is measured (for example, a UV-visible near-infrared spectrophotometer V-570 manufactured by JASCO Corporation is used). Then, the absorption coefficient β is calculated by using the relation of T=^{-βt}.

In the cover member including the glass of the present embodiment and the printing layer, the absorption coefficient and the absorbance at the wavelength in a range of 380 nm to 780 nm can be calculated by the same method as that used in the embodiment of the above-described substantially colorless transparent glass.

In addition, in order to obtain the glass exhibiting black color, in the glass of the present embodiment, a relative value, which is calculated from the spectrum permeability curve, of the absorption coefficient at the wavelength of 550 nm with respect to the absorption coefficient at the wavelength of 600 nm (hereinafter, the relative value of the absorption coefficient may be denoted as “absorption coefficient at the wavelength of 550 nm/absorption coefficient at the wavelength of 600 nm”), and a relative value, which is calculated from the spectrum permeability curve, of the absorption coefficient at the wavelength of 450 nm with respect to the absorption coefficient at the wavelength of 600 nm (hereinafter, the relative value of the absorption coefficient may be denoted as “absorption coefficient at the wavelength of 450 nm/absorption coefficient at the wavelength of 600 nm”) are preferably in a range of 0.7 to 1.2. As described above, it is possible to obtain the glass exhibiting black color by selecting a predetermined component as the glass coloring component. However, in accordance with the kinds of the coloring components and the mixing amount thereof, although it is black, it may be brownish or bluish, for example. In order to express black which is not recognized as another color, that is, jet black in the glass, the glass having less variation in the absorption coefficient in the light wavelength of the visible region, that is, the glass which absorbs the light in the visible region on average is preferable. Accordingly, the range of the relative value of the absorption coefficient is preferably in a range of 0.7 to 1.2. When the aforementioned range is smaller than 0.7, the black may be bluish. In addition, when the aforementioned range is greater than 1.2, the black may be brownish or bluish. The relative value of the absorption coefficient means that when both the absorption coefficient at the wavelength of 450 nm/absorption coefficient at the wavelength of 600 nm and the absorption coefficient at the wavelength of 550 nm/absorption coefficient at the wavelength of 600 nm are within the above-described range, it is possible to obtain the black glass which is not recognized as another color.

In order to control the absorption coefficient at the wavelength in a range of 380 nm to 780 nm to be 1 mm⁻¹ or higher, it is preferable that a plurality of coloring components are combined such that the absorption coefficients of the light at the wavelength range are high on average. For example, as the coloring component in the glass, when 1.5% to 6% of Fe₂O₃ and 0.1% to 1% of Co₃O₄ are contained in combination, while sufficiently absorbing the light of the visible region having the wavelength in a range of 380 nm to 780 nm, it is possible to make the glass which absorbs the light of the visible region on average. That is, in a case where the glass exhibiting black color is intended to be obtained, the wavelength region with low absorption properties may be present in the visible region having the wavelength in a range of 380 nm to 780 nm in accordance with the kinds of the coloring components and the mixing amount thereof, and thus, the black may be brownish or bluish. In contrast, when the aforementioned coloring components are contained in the glass, it is possible to exhibit so-called jet black. In addition, when the coloring components are combined in the glass, it is possible to obtain the glass through which specific wavelength such as ultraviolet light and infrared light transmits while sufficiently absorbing the light of the visible region having the wavelength in a range of 380 nm to 780 nm. For example, when the glass contains the aforementioned Fe₂O₃, Co₃O₄, NiO, MnO, Cr₂O₃, and V₂O₅ in combination as the coloring components, the ultraviolet light having the wavelength of 300 nm to 380 nm and the infrared light having the wavelength of 800 nm to 950 nm can transmit through the glass. Further, when the glass contains the aforementioned Fe₂O₃ and Co₃O₄ in combination as the coloring components, the infrared light having the wavelength of 800 nm to 950 nm can transmit the glass.

In addition, the glass of the present embodiment may contain crystals derived from the glass component therein. The color of the aforementioned crystal depends on the kinds of the crystal and, for example, black and white can be adopted.

As the substantially black glass used in the cover member of the present embodiment, for example, any one of the following glasses (vi) to (vii) may be used. The following glass compositions are represented by mol % in terms of oxides.

(vi) A glass containing 55% to 80% of SiO₂, 0.25% to 16% of Al₂O₃, 0% to 12% of B₂O₃, 5% to 20% of Na₂O, 0% to 15% of K₂O, 0% to 15% MgO, 0% to 15% of CaO, 0% to 25% of ΣRO (R is Mg, Ca, Sr, Ba, and Zn), and 0% to 1% of ZrO₂, and further contains 0.001% to 7% of MpOq (here, M is at least one selected from Fe, Se, Co, Cu, V, Cr, Pr, Ce, Bi, Eu, Mn, Er, Ni, Nd, W, Rb, Sn, and Ag, and p and q are atom ratios with respect to M and O) as the coloring component.

(vii) A glass containing 55% to 80% of SiO₂, 3% to 16% of Al₂O₃, 0% to 12% of B₂O₃, 5% to 16% of Na₂O, 0% to 4% of K₂O, 0% to 15% of MgO, 0% to 3% of CaO, 0% to 18% of ΣRO (R is Mg, Ca, Sr, Ba, and Zn), and 0% to 1% of ZrO₂, and further contains 0.1% to 7% of MpOq (here, M is at least one selected from Fe, Se, Co, Cu, V, Cr, Pr, Ce, Bi, Eu, Mn, Er, Ni, Nd, W, Rb, Sn, and Ag, and p and q are atom ratios with respect to M and O) as the coloring component.

(Phase-Separated Glass)

In a phase-separated glass of the present embodiment, particles in the dispersed phase in the glass diffusely reflect and scatter light, thereby imparting white color to the appearance thereof. The phase separation of the glass means that a single phase glass is divided into two or more glass phases. Examples of a method of phase separation of the glass include a method of subjecting the glass to a heat treatment.

The temperature of the heat treatment for the phase separation of the glass is preferably higher than a glass transition point by 50° C. to 400° C., and is more preferably higher than the glass transition point by 100° C. to 300° C. The time for the heat treatment of the glass is preferably in a range of 1 to 64 hours, and is more preferably 2 to 32 hours. The time for the heat treatment of the glass is preferably 24 hours or shorter, and is more preferably 12 hours or shorter from the viewpoint of the mass productivity. In the phase separation step in which the glass is subjected to phase-separation before forming step of forming the glass, it is preferable to hold the glass at the phase separation starting temperature or lower, and the temperature higher than 1000° C. It is possible to determine whether the glass is phase-separated or not by using a scanning electron microscope (SEM). When the phase-separated glass is observed by the SEM, it is possible to observe the glass in which the phase is divided into two or more phases.

Examples of the phase-separated glass state include a binodal state and a spinodal state. The binodal state means a phase separation by a nucleation-growth mechanism, and is generally formed into a spherical shape. Specifically, the binodal state is a state in which one separated phase having an independent spherical shape is dispersed into a matrix of the other separated phase. In addition, the spinodal state means a state in which the separated phases are mutually and continuously entwined with each other in three dimensions with regularity to some extent.

In order to increase CS by subjecting the phase-separated glass to the chemical strengthening, the phase-separated glass which is subjected to the chemical strengthening is to be preferably in the binodal state.

The phase-separated glass is preferably white-colored. In the transmittance of the phase-separated glass, transmittance T400 of the glass having a thickness of 1 mm with respect to the light having the wavelength of 400 nm is preferably 70% or lower, is more preferably 30% or lower, is still more preferably 20% or lower, is even still more preferably 10% or lower, is even still more preferably 5% or lower, is particularly preferably 3% or lower, and is most preferably 1% or lower. When the transmittance T400 of the glass having a thickness of 1 mm with respect to the light having the wavelength of 400 nm is controlled to be 30% or lower, the phase-separated glass can be sufficiently white-colored. The transmittance can be evaluated based on general transmittance measurement (linear transmittance measurement).

In addition, in the transmittance of the phase-separated glass of the present embodiment, all of the transmittance T800 with respect to the light having the wavelength of 800 nm, the transmittance T600 with respect to the light having the wavelength of 600 nm, and the transmittance T400 with respect to the light having the wavelength of 400 nm, of the glass having a thickness of 1 mm are preferably 30% or lower, are more preferably 10% or lower, are still more preferably 5% or lower, and are most preferably 1% or lower.

In addition, as the cover member, in a case where the printing layer is provided on the second surface of the phase-separated glass of the present embodiment, regarding the transmittance of the cover member including the phase-separated glass of the present embodiment and the printing layer, all of the transmittance T800 of the with respect to the light having the wavelength of 800 nm, the transmittance T600 with respect to the light having the wavelength of 600 nm, and the transmittance T400 with respect to the light having the wavelength of 400 nm glass having a thickness of 1 mm are preferably 20% or lower, is more preferably 10% or lower, is still more preferably 5% or lower, and is most preferably 1% or lower.

In addition, in the phase-separated glass of the present embodiment, the minimum value of the total light reflectance is preferably 10% or higher, is more preferably 30% or higher, is still more preferably 50% or higher, and is particularly preferably 70% or higher, in terms of the thickness of 1 mm, with respect to the light having the wavelength in a range of 400 nm to 800 nm. When the minimum value of the total light reflectance is 10% or higher, the phase-separated glass can be white-colored.

Further, in a case where the printing layer is provided as the cover member on the second surface of the phase-separated glass of the present embodiment, the minimum value of the total light reflectance of the cover member including the glass of the present embodiment and the printing layer is preferably 30% or higher, is more preferably 50% or higher, and is still more preferably 70% or higher, in terms of the thickness of 1 mm, with respect to the light having a wavelength in a range of 400 nm to 800 nm. When the minimum value of the total light reflectance is 30% or higher, the desired light shielding properties can be obtained, and thus, it is possible to effectively prevent the light from transmitting through the cover member.

In order to white-color the phase-separated glass, an average size of one phase in the phase-separated state or an average particle size of the separated phase in the phase-separated glass is preferably in a range of 40 to 3000 nm, is more preferably in a range of 50 to 2000 nm, and is typically in a range of 100 nm or more and 1000 nm or less. The average particle size of the separated phase can be measured by SEM observation. Regarding the average size of one phase in the phase-separated state, it means an average width of the phases which are mutually and continuously entwined with each other in the spinodal state, and it means the diameter of the one phase in a case where the one phase is formed into a spherical shape, or an average value of the major axis and minor axis in a case where the one phase is formed into an oval spherical shape in the binodal state. Further, the average particle size of the separated phase means the average size in the binodal state.

In addition, in order to white-color the phase-separated glass, a refractive index difference between the particle of the separated phase and the matrix around the particle in the phase-separated glass is preferably large.

Further, the volume ratio of the particles of the separated phase in the phase-separated glass is preferably 5% or higher, is more preferably 10% or higher, and is still more preferably 20% or higher. The ratio of dispersed particles distributed on the glass surface is calculated from the SEM observation picture so as to estimate the volume ratio of the particles of the separated phase from the ratio of the dispersed particles.

Hereinafter, in a case where % is used for the composition of the glass, it is assumed to be represented by mol % in terms of oxides. The contents of SiO₂, Al₂O₃, MgO, Na₂O, ZrO₂, TiO₂, K₂O, Li₂O, CaO, and SrO are the same as those of the above-described substantially colorless transparent glass.

B₂O₃ is a component of forming network of glass and improving the weatherability. In the case of the phase-separated glass of the present embodiment, the content of B₂O₃ is preferably 8% or less, is more preferably 6% or less, and is still more preferably 4% or less in order to particularly prevent striae due to volatilization.

P₂O₅ is a component of forming network of glass and prompting the white-coloring. In the case of the phase-separated glass of the present embodiment, the content of P₂O₅ is preferably 0.5% or more, is more preferably 2% or more, and is still more preferably 3% or more. In order to improve the weatherability, the content of P₂O₅ is preferably 10% or less, is more preferably 8% or less, is still more preferably 7% or less, and is particularly preferably 6% or less.

La₂O₃ is a component of increasing the relative permittivity. The content of La₂O₃ is preferably in a range of 0% to 2%, and is more preferably in a range of 0.2% to 1%.

BaO is a component of increasing the relative permittivity and the meltability. Further, BaO has an excellent effect of prompting the light shielding properties as compared with other alkaline earth metal oxides. In order to make it difficult to scratch the phase-separated glass of the present embodiment, the content of BaO is preferably 8% or lower, is more preferably 5% or lower, and is still more preferably 2% or lower.

Nb₂O₅ and Gd₂O₃ are components of increasing the relative permittivity. In a case of containing at least one of Nb₂O₅ and Gd₂O₃, the content thereof is preferably in a range of 0.5% to 10%, is more preferably in a range of 1% to 8%, is still more preferably in a range of 2% to 6%, and is particularly preferably in a range of 3% to 5%. When the content of at least one of Nb₂O₅ and Gd₂O₃ is controlled to be 0.5% or more, it is possible to sufficiently obtain an effect of making the refractive index difference of two phase-separated glass large, and thus, the light shielding properties can be improved. On the other hand, when the content of at least one of Nb₂O₅ and Gd₂O₃ is controlled to be 10% or less, it is possible to prevent the glass from being weakened. The content of Nb₂O₅ is preferably in a range of 0% to 10%, is more preferably in a range of 1% to 8%, is still more preferably in a range of 2% to 6%, and is particularly preferably in a range of 3% to 5%. The content of Gd₂O₃ is preferably in a range of 0% to 10%, is more preferably in a range of 1% to 8%, is still more preferably in a range of 2% to 6%, and is particularly preferably in a range of 3% to 5%.

The phase-separated glass may contain, as the coloring component, Co, Mn, Fe, Ni, Cu, Cr, V, Bi, Er, Tm, Nd, Sm, Sn, Ce, Pr, Eu, Ag, or Au or oxides thereof. The coloring component is preferably 5% or less based on the composition represented by mol % in terms of minimum valence oxides. Further, SO₃, chloride, or fluoride may be properly contained as the clarifying agent at the time of melting the glass.

As the phase-separated glass used in the cover member of the present embodiment, for example, any one of the following glasses (viii) to (xii) may be used. The following glass compositions are represented by mol % in terms of oxides.

(viii) A glass containing 50% to 80% of SiO₂, 0% to 4% of B₂O₃, 0% to 10% of Al₂O₃, 5% to 30% of MgO, and 1% to 17% of Na₂O, in which the total content of at least one selected from ZrO₂, P₂O₅, TiO₂, and La₂O₃ is in a range of 0.5% to 10%.

(ix) A glass containing 50% to 80% of SiO₂, 0% to 6% of B₂O₃, 0% to 10% of Al₂O₃, 5% to 30% of MgO, and 1% to 17% of Na₂O, 0% to 9% of K₂O, and 0% to 10% of P₂O₅.

(x) A glass containing 50% to 80% of SiO₂, 0% to 7% of B₂O₃, 0% to 10% of Al₂O₃, 0% to 30% of MgO, 5% to 15% of Na₂O, 0% to 5% of CaO, 0% to 15% of BaO, and 0% to 10% of P₂O₅, in which the total content of MgO, CaO, and BaO is in a range of 10% to 30%.

(xi) A glass containing 50% to 73% of SiO₂, 0% to 10% of B₂O₃, and 3% to 17% of Na₂O, 0.5% to 10% of at least one of Nb₂O₅ and Gd₂O₃, and 0.5% to 10% of P₂O₅, in which the total content of MgO, CaO, SrO, and BaO is in a range of 2% to 25%.

(xii) A glass containing 55% to 65% of SiO₂, 1% to 6% of B₂O₃, 0% to 8% of Al₂O₃, 1% to 16% of MgO, 0% to 16% of BaO, 6% to 12% of Na₂O, 0% to 5% of ZrO₂, 1% to 8% of Nb₂O₅, and 2% to 8% of P₂O₅, in which the total content of MgO, CaO, SrO, and BaO is in a range of 2% to 20%.

(Cover Glass)

In addition, in the present invention, as the cover glass used in the cover member according to the first embodiment, a cover glass which includes the chemically strengthened glass having the Young's modulus of 60 GPa or higher and the thickness t of 0.4 mm or less is provided. The “cover glass” in the present embodiment is not the concept that is limited to the cover glass formed of the chemically strengthened glass, but is the concept that a printing layer or an antiglare layer is also included together with the chemically strengthened glass in a case where the printing layer or the antiglare layer is formed on the surface of the chemically strengthened glass.

### Second Embodiment

Subsequently, the second embodiment of the present invention will be described.

(Cover Member)

A cover member according to the second embodiment of the present invention includes at least a glass, in which the glass has a Young's modulus of 60 GPa or higher, the glass includes a first surface and a second surface facing the first surface, and the glass has a thickness t of 0.4 mm or less. The cover member according to the second embodiment basically has the same configuration as that of the cover member according to the first embodiment except that the glass that forms the cover glass is not strengthened (non-strengthened glass). As described in the present embodiment, even in a case where the glass that forms the cover member (cover glass) is not chemically strengthened (non-strengthened glass), as long as the Young's modulus of the glass is 60 GPa or higher and the thickness of the glass is 0.4 mm or less, the cover member including the glass greatly contributes to the improvement of the sensitivity of the capacitance sensor, and has high mechanical strength, and thus, it can be efficiently used as a cover member for a capacitance sensor such as a fingerprint authentication sensor.

The thickness, the Young's modulus, the Vickers hardness Hv, the relative permittivity at a frequency of 1 MHz, the arithmetic average roughness (Ra) of the surface (the first surface and the second surface), the absorbance, the absorption coefficient and the like of the glass of the cover member of the present embodiment are based on those of the chemically strengthened glass in the cover member of the first embodiment. In addition, similar to the cover member of the first embodiment, the cover member of the present embodiment may further include a printing layer or the like as well. Further, the glass compositions of the glass in the cover member of the present embodiment can be properly selected and adopted from the compositions described as the glass to be chemically strengthened in the first embodiment. Further, the absorbance, the absorption coefficient, and the like of the cover member of the present embodiment are also based on those of the cover member of the first embodiment. Accordingly, the detailed description for these will be omitted.

(Cover Glass)

In addition, in the present invention, as the cover glass used in the cover member according to the second embodiment, the cover glass which includes the glass having the Young's modulus of 60 GPa or higher and the thickness t of 0.4 mm or less is provided. The “cover glass” in the present embodiment is not the concept that is limited to the cover glass formed of the glass, but is the concept that a printing layer or an antiglare layer are also included together with the glass in a case where the printing layer or the antiglare layer is formed on the surface of the glass.

(Capacitance Sensor)

The cover member of the present embodiment is suitably used as a cover member for a capacitance sensor, and can be used without being particularly limited as long as it is used for a capacitance sensor. The capacitance sensor can be variously used for touch panels of portable devices such as smart phones, automatic teller machines for banks, door locks for cars, personal authentication devices for entrance management into building, and the like. In addition, a capacitance sensor having a fingerprint authentication function (hereinafter, may be simply referred to as a fingerprint authentication sensor) can be preferably used for particularly portable devices such as smartphones, cell phones, and tablet personal computers. Hereinafter, the capacitance sensor including the cover member of the present embodiment will be described as an example of the fingerprint authentication sensors.

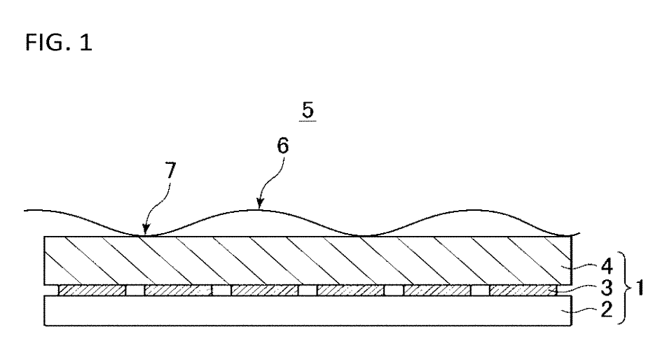

FIG. 1 illustrates a cross-sectional view of an example of a fingerprint authentication sensor. In the fingerprint authentication sensor 1 illustrated in FIG. 1, a plurality of electrodes 3 are provided on a substrate 2 with a predetermined space therebetween, and a cover member 4 is provided on the plurality of electrodes. Although not illustrated in FIG. 1, also in the direction orthogonal to the page, the plurality of electrodes 3 are provided on the substrate 2 with a predetermined space therebetween. When a finger 5 contacts with the cover member 4, charges are accumulated between the finger 5 and the electrode 3 in accordance with the degree of convex and concave of the fingerprint of the finger 5. Here, as the distance between the finger 5 and the electrode 3 becomes larger, the capacitance becomes smaller, and the amount of the accumulated charges becomes decreased. Accordingly, in a valley (concave portion) 6 of the finger 5, the distance between the valley (concave portion) 6 and the electrode 3 is large, and thus, the amount of the accumulated charges becomes decreased. On the other hand, in a mountain (convex portion) 7 of the finger 5, the distance between the mountain (convex portion) 7 and the electrode 3 is small, and thus, the amount of the accumulated charges becomes increased. The amount of the accumulated charges at the respective points which are indicated as described above is measured and converted into an image such that the shape of the fingerprint is detected as an image.

The cover member of the present embodiment includes at least the chemically strengthened glass or the glass, which has high Young's modulus of 60 GPa or higher and a small thickness of 0.4 mm or less. Accordingly, the cover member of the present embodiment greatly contributes to the improvement of the sensitivity of the capacitance sensor, and has high mechanical strength, and thus, it can be efficiently used as a cover member for a capacitance sensor such as a fingerprint authentication sensor.

### EXAMPLES

Hereinafter, the present invention will be described in accordance with Examples; however, the present invention is not limited thereto.

### Examples 1 to 8

Regarding the respective Examples 1 to 8 indicated in Table 1, generally used glass raw materials such as oxides, hydroxides, carbonates, or nitrates were properly selected so as to have a composition represented by molar percentage in the column of “Composition (mol %)”, and were weighted so as to be 300 cm³ as glass.

Regarding Examples 1 to 3, the mixed raw materials were put into a platinum crucible, and then the platinum crucible was put into a resistance heating electric furnace at a temperature of 1500° C. to 1600° C. to melt, defoam, and homogenize the mixed raw materials for one hour. Thereafter, the obtained molten glass flowed into a die, was held for two hours at the temperature of approximately 630° C., and cooled down to room temperature at a rate of 1° C./min, thereby obtaining a glass block.

Regarding Examples 4, 5, 7, and 8, the mixed raw materials were put into a platinum crucible, and then the platinum crucible was put into a resistance heating electric furnace at a temperature of 1550° C. to 1650° C. to melt, defoam, and homogenize the mixed raw materials for three to five hours. Thereafter, the obtained molten glass flowed into a die, and cooled down to room temperature at a rate of 1° C./min, thereby obtaining a glass block.

Regarding Example 6, the mixed raw materials were put into a platinum crucible, and then the platinum crucible was put into a resistance heating electric furnace at a temperature of 1600° C. to melt, defoam, and homogenize the mixed raw materials for 120 minutes. Thereafter, the temperature of the furnace was decreased to 1390° C., held at a phase separation starting temperature or lower for 30 minutes, then the obtained molten glass flowed into a die, and the die was cooled down to room temperature at a rate of 1° C./min after being held at 630° C. for approximately one hour, thereby obtaining a glass block.

The obtained glass blocks were cut and ground, and both surfaces thereof were mirror polished at last, thereby obtaining a plate glass having a size of 15 mm×15 mm, and a thickness t of 0.2 mm.

Subsequently, a chemically strengthened glass according to Examples 1 to 6 was obtained by subjecting each glass in Examples 1 to 6 to the chemical strengthening treatment. The conditions for the chemical strengthening are as follows: regarding Examples 1 to 3, a glass was immersed into 99% potassium nitrate molten salt at 425° C. for one hour; regarding Examples 4 and 5, a glass was immersed into 100% potassium nitrate molten salt at 425° C. for one hour; and regarding Example 6, a glass was immersed into 100% potassium nitrate molten salt at 450° C. for six hours.

The measurement or calculation results of the Young's modulus (unit: GPa), the Vickers hardness Hv, the relative permittivity at a frequency of 1 MHz, the surface compressive stress (CS, unit: MPa), the thickness of the compressive stress layer (DOL, unit: μm), the maximum value of the internal tensile stress (CTmax, unit: MPa), and the value of DOL/t of each chemically strengthened glass according to Examples 1 to 6 are indicated in Table 1.

In addition, the measurement results of the Young's modulus (unit: GPa), the Vickers hardness Hv, and the relative permittivity at a frequency of 1 MHz of each glass (non-strengthened glass) according to Examples 7 and 8 are indicated in Table 1.

In addition, the measurement or calculation results of the absorbance (without unit, wavelength of 750 nm or 780 nm) in the thickness of 0.2 mm, and the absorption coefficient (unit: mm⁻¹, wavelength 750 nm or 780 nm) of each chemically strengthened glass according to Examples 1 to 3 are indicated in Table 1. The obtained values of the absorbance and the absorption coefficient are the minimum values at the wavelength in a range of 380 nm to 780 nm.

TABLE 1

| | | Example 1 | Example 2 | Example 3 | Example 4 | Example 5 | Example 6 | Example 7 | Example 8 |
|---|---|---|---|---|---|---|---|---|---|
| Color | | Colored glass | | | Substantially colorless | | Phase- | Substantially colorless | |
| | | | | | transparent glass | | separated | transparent glass | |
| | | | | | | | glass | | |
| | | Black | Gray | Black | Colorless | Colorless | White | Colorless | Colorless |
| Strengthening treatment/ | | Chemically strengthened | | | | | | Non-strengthened | |
| non-strengthening treatment | | | | | | | | | |
| Compositions | SiO₂ | 62.0 | 63.1 | 69.3 | 64.4 | 68.0 | 60.7 | 71.1 | 66.1 |
| (mol %) | B₂O₃ | | | | | | 3.9 | | 7.4 |
| | P₂O₅ | | | | | | 5.1 | | |
| | Al₂O₃ | 7.7 | 7.9 | 5.8 | 8.0 | 10.0 | 3.4 | 1.1 | 11.2 |
| | Na₂O | 12.1 | 12.3 | 11.6 | 12.5 | 14.0 | 9.3 | 12.4 | |
| | K₂O | 3.9 | 3.9 | | 4.0 | | | 0.2 | |
| | CaO | | | | 0.1 | | | 8.3 | 4.9 |
| | MgO | 10.1 | 10.3 | 9.6 | 10.5 | 8.0 | 7.6 | 6.9 | 5.4 |
| | BaO | | | | 0.1 | | 7.6 | | 0.0 |
| | SrO | | | | | | | | 4.9 |
| | CuO | | 1.0 | | | | | | |
| | NiO | | 0.7 | | | | | | |
| | TiO₂ | | 0.3 | | | | | | |
| | ZrO₂ | 0.5 | 0.4 | | 0.5 | | 2.5 | | |
| | Fe₂O₃ | 3.3 | | 3.3 | | | | | |
| | Co₃O₄ | 0.4 | 0.1 | 0.4 | | | | | |
| | SO₃ | 0.1 | 0.1 | 0.1 | | | | | |

| | | | | | | | | |
|---|---|---|---|---|---|---|---|---|
| Young's modulus (GPa) | 77 | 74 | 74 | 74 | 72 | 71 | 76 | 72 |
| Relative permittivity εᵣ | 7.8 | 7.5 | 7.7 | 7.7 | 8.4 | 7.8 | 7.4 | 5.6 |
| (1 MHz) | | | | | | | | |
| Vickers hardness Hv | 577 | 580 | 523 | 560 | 530 | 620 | 535 | 580 |
| CS (MPa) | 709 | 662 | 725 | 640 | 864 | 479 | — | — |
| DOL (μm) | 28 | 33 | 15 | 20 | 15 | 20 | — | — |
| CTmax (MPa) | 138< | 163< | 64< | 80< | 76< | 60< | — | — |
| DOL/t (—) | 0.14 | 0.17 | 0.08 | 0.10 | 0.08 | 0.10 | — | — |
| Glass thickness (mm) | 0.20 | 0.20 | 0.20 | 0.20 | 0.20 | 0.20 | 0.20 | 0.20 |
| Absorbance | 0.22 | 0.08 | 0.32 | — | — | — | — | — |
| (Plate thickness: 0.2 mmt) | (wavelength | (wavelength | (wavelength | | | | | |
| | 780 nm) | 750 nm) | 780 nm) | | | | | |
| Absorption coefficient | 1.1 | 0.41 | 1.58 | — | — | — | — | — |
| (mm⁻¹) | (wavelength | (wavelength | (wavelength | | | | | |
| | 780 nm) | 750 nm) | 780 nm) | | | | | |

All of the chemically strengthened glasses of the respective Examples have small thickness t of 0.2 mm and high Young's modulus of 60 GPa or higher.

### Comparative Examples 1 to 7

Next, the chemically strengthened glass of Comparative Examples 1 to 3 was manufactured in the same manner as the chemically strengthened glass of Examples 1 to 3 except that the thickness t was 0.8 mm. In addition, the chemically strengthened glass of Comparative Examples 4 and 5 was manufactured in the same manner as the chemically strengthened glass of Examples 4 and 5 except that the thickness t was 0.8 mm. Further, the chemically strengthened glass of Comparative Example 6 was manufactured in the same manner as the chemically strengthened glass of Example 6 except that the thickness t was 0.8 mm. The measurement or calculation results of the Young's modulus (unit: GPa), the Vickers hardness Hv, the relative permittivity at a frequency of 1 MHz, the surface compressive stress (CS, unit: MPa), the thickness of the compressive stress layer (DOL, unit: μm), the maximum value of the internal tensile stress (CTmax, unit: MPa), and DOL/t of the chemically strengthened glass according to Comparative Examples 1 to 6 are indicated in Table 2.

Regarding the Comparative Example 7 indicated in Table 2, generally used glass raw materials such as oxides, hydroxides, carbonates, or nitrates were properly selected so as to have a composition represented by molar percentage in the column of “Composition (mol %)”, and were weighted so as to be 300 cm³ as glass. In addition, the mixed raw materials were put into a platinum crucible, and then the platinum crucible was put into a resistance heating electric furnace at a temperature of 1550° C. to 1650° C. to melt, defoam, and homogenize the mixed raw materials for three to five hours. Thereafter, the obtained molten glass flowed into a die, and cooled down to room temperature at a rate of 1° C./min, thereby obtaining a glass block. The obtained glass block was cut and ground, and both surfaces thereof were mirror polished at last, thereby obtaining a plate glass of Comparative Example 7 having a size of 15 mm×15 mm, and a thickness t of 0.2 mm.

The measurement results of the Young's modulus (unit: GPa), the Vickers hardness Hv, and the relative permittivity at a frequency of 1 MHz of the glass (non-strengthened glass) of Comparative Example 7 are indicated in Table 2.

TABLE 2

| | | Comparative | Comparative | Comparative | Comparative | Comparative | Comparative | Comparative |
|---|---|---|---|---|---|---|---|---|
| | | Example 1 | Example 2 | Example 3 | Example 4 | Example 5 | Example 6 | Example 7 |
| Color | | Colored glass | | | Substantially colorless | | Phase- | Substantially colorless |
| | | | | | transparent glass | | separated | transparent glass |
| | | | | | | | glass | |
| | | Black | Gray | Black | Colorless | Colorless | White | Colorless |
| Strengthening treatment/ | | Chemically strengthened | | | | | | Non-strengthened |
| non-strengthening treatment | | | | | | | | |
| Compositions | SiO₂ | 62.0 | 63.1 | 69.3 | 64.4 | 68.0 | 60.7 | 60.1 |
| (mol %) | B₂O₃ | | | | | | 3.9 | |
| | P₂O₅ | | | | | | 5.1 | |
| | Al₂O₃ | 7.7 | 7.9 | 5.8 | 8.0 | 10.0 | 3.4 | 14.7 |
| | Na₂O | 12.1 | 12.3 | 11.6 | 12.5 | 14.0 | 9.3 | |
| | K₂O | 3.9 | 3.9 | | 4.0 | | | 25.3 |
| | CaO | | | | 0.1 | | | |
| | MgO | 10.1 | 10.3 | 9.6 | 10.5 | 8.0 | 7.6 | |
| | BaO | | | | 0.1 | | 7.6 | |
| | SrO | | | | | | | |
| | CuO | | 1.0 | | | | | |
| | NiO | | 0.7 | | | | | |
| | TiO₂ | | 0.3 | | | | | |
| | ZrO₂ | 0.5 | 0.4 | | 0.5 | | 2.5 | |
| | Fe₂O₃ | 3.3 | | 3.3 | | | | |
| | Co₃O₄ | 0.4 | 0.1 | 0.4 | | | | |
| | SO₃ | 0.1 | 0.1 | 0.1 | | | | |

| | | | | | | | |
|---|---|---|---|---|---|---|---|
| Young's modulus (GPa) | 77 | 74 | 74 | 74 | 72 | 71 | 59 |
| Relative permittivity εᵣ | 7.8 | 7.5 | 7.7 | 7.7 | 8.4 | 7.8 | 10.15 |
| (1 MHz) | | | | | | | |
| Vickers hardness Hv | 577 | 580 | 523 | 560 | 530 | 620 | 579 |
| CS (MPa) | 866 | 827 | 906 | 800 | 1080 | 599 | — |
| DOL (μm) | 28 | 33 | 15 | 20 | 15 | 20 | — |
| CTmax (MPa) | 33 | 37 | 18 | 21 | 21 | 16 | — |
| DOL/t (—) | 0.04 | 0.04 | 0.02 | 0.03 | 0.02 | 0.03 | — |
| Glass thickness (mm) | 0.80 | 0.80 | 0.80 | 0.80 | 0.80 | 0.80 | 0.20 |

The chemically strengthened glass or the non-strengthened glass of Examples 1 to 8 was used as the cover member, a plurality of electrodes were provided on a substrate with a predetermined space therebetween as illustrated in FIG. 1, and then the cover member was provided on the plurality of electrodes to form a fingerprint authentication sensor. All of the fingerprint images which were detected by using the fingerprint authentication sensor including the chemically strengthened glass or the non-strengthened glass of Examples 1 to 7 as a cover member were clear. In addition, in the same way, the fingerprint image detected by using the fingerprint authentication sensor including the non-strengthened glass of Example 8 as the cover member was slightly blurred, but it was not serious.

On the other hand, the chemically strengthened glass of Comparative Examples 1 to 6 was used as the cover member, a plurality of electrodes were provided on a substrate with a predetermined space therebetween as illustrated in FIG. 1, and then the cover member was provided on the plurality of electrodes to form a fingerprint authentication sensor. All of the fingerprint images which were detected by using the fingerprint authentication sensor including the chemically strengthened glass of Comparative Examples 1 to 6 as a cover member were not clear.

Further, as a result of the evaluation of the mechanical strength when the chemically strengthened glass or the non-strengthened glass of Examples 1 to 8, and the non-strengthened glass of Comparative Example 7 are used as the cover member, while the chemically strengthened glass or the non-strengthened glass of Examples 1 to 8 has high mechanical strength as a cover member, the non-strengthened glass of Comparative Example 7 has insufficient mechanical strength.

As described above, in the respective Examples, the chemically strengthened glass or the non-strengthened glass are suitably used as a material for forming a cover member for a capacitance sensor.

The present invention has been described in detail with reference to specific embodiments; however, it will be apparent to those skilled in the art that various changes and modifications can be made without departing from the spirit and scope of the invention.

This application is based on a Japanese patent application No. 2014-213224 filed on Oct. 17, 2014, the entirety of which is incorporated by reference.

### REFERENCE SIGNS LIST

1: Fingerprint Authentication Sensor
2: Substrate
3: Electrode
4: Cover Member
5: Finger
6: Valley (Concave Portion)
7: A Mountain (Convex Portion)

1. A cover member comprising at least a chemically strengthened glass, wherein
the chemically strengthened glass has a Young's modulus of 60 GPa or higher,
the chemically strengthened glass includes a first surface and a second surface facing the first surface, and
the chemically strengthened glass has a thickness t of 0.4 mm or less.

2. The cover member according to claim 1, wherein
the chemically strengthened glass has a relative permittivity at a frequency of 1 MHz of 5 or higher.

3. The cover member according to claim 2, wherein
the chemically strengthened glass has the relative permittivity at a frequency of 1 MHz of 7 or higher.

4. The cover member according to claim 1, wherein
a depth DOL of a surface compressive stress layer of the chemically strengthened glass satisfies the relation of DOL/t≧0.05.

5. The cover member according to claim 1, wherein
a printing layer is provided on the second surface of the chemically strengthened glass, and
the printing layer has a thickness of 20 μm or less.

6. The cover member according to claim 1, wherein
a surface roughness Ra of the first surface of the chemically strengthened glass is 300 nm or lower.

7. A cover member comprising at least a glass, wherein
the glass has a Young's modulus of 60 GPa or higher,
the glass includes a first surface and a second surface facing the first surface, and
the glass has a thickness t of 0.4 mm or less.

8. The cover member according to claim 7, wherein
the glass has a relative permittivity at a frequency of 1 MHz of 5 or higher.

9. The cover member according to claim 8, wherein
the glass has the relative permittivity at a frequency of 1 MHz of 7 or higher.

10. The cover member according to claim 7, wherein
a printing layer is provided on the second surface of the glass, and
the printing layer has a thickness of 20 μm or less.

11. The cover member according to claim 7, wherein
a surface roughness Ra of the first surface of the glass is 300 nm or lower.

12. The cover member according to claim 1, which has a minimum value of an absorption coefficient at a wavelength in a range of 380 nm to 780 nm of 0.7 mm⁻¹ or higher.

13. The cover member according to claim 1, which has a minimum value of an absorbance at a wavelength in a range of 380 nm to 780 nm of 0.01 or higher.

14. The cover member according to claim 1, which has a minimum value of a total light reflectance at a wavelength in a range of 400 nm to 800 nm is 30% or higher in terms of a thickness of 1 mm.

15. The cover member according to claim 1, which is used for a capacitance sensor.

16. The cover member according to claim 15, which is used for a fingerprint authentication sensor.

17. A cover glass comprising a chemically strengthened glass which has a Young's modulus of 60 GPa or higher and a thickness t of 0.4 mm or less.

18. A cover glass comprising a glass which has a Young's modulus of 60 GPa or higher and a thickness t of 0.4 mm or less.

19. The cover member according to claim 7, which has a minimum value of an absorption coefficient at a wavelength in a range of 380 nm to 780 nm of 0.7 mm⁻¹ or higher.

20. The cover member according to claim 7, which has a minimum value of an absorbance at a wavelength in a range of 380 nm to 780 nm of 0.01 or higher.

21. The cover member according to claim 7, which has a minimum value of a total light reflectance at a wavelength in a range of 400 nm to 800 nm is 30% or higher in terms of a thickness of 1 mm.

22. The cover member according to claim 7, which is used for a capacitance sensor.

23. The cover member according to claim 22, which is used for a fingerprint authentication sensor.
